(19) United States
(12) Patent Application Publication
(10) Pub. No.: US 2011/0013100 A1
(43) Pub. Date: Jan. 20, 2011

(54) DISPLAY UNIT, METHOD OF DRIVING THE SAME, AND ELECTRONICS DEVICE

(75) Inventor: Hideki Sugimoto, Kanagawa (JP)

Correspondence Address: SNR DENTON US LLP, P.O. BOX 061080, CHICAGO, IL, 60606-1080, US

(73) Assignee: SONY CORPORATION, Tokyo (JP)

(21) Appl. No.: 12/831,677

(22) Filed: Jul. 7, 2010

(30) Foreign Application Priority Data
Jul. 14, 2009 (JP) 2009-165378

(51) Int. Cl. H04N 5/70; G09G 5/00

(52) U.S. Cl. 348/800; 345/211; 348/E05.135

(57) ABSTRACT

A display unit with which gradation control is facilitated, a method of driving the same, and an electronics device are provided. The display unit includes: a pixel circuit array section including a plurality of scanning lines arranged in rows, a plurality of signal lines arranged in columns, and a plurality of light emitting devices and a plurality of pixel circuits arranged in a matrix state correspondingly to an intersection of each scanning line and each signal line; a signal line drive circuit sequentially applying a signal voltage corresponding to a video signal to each signal line, and applying an erasing pulse to a specific signal line at given timing so that a duty ratio determined based on the video signal is obtained; and a scanning line drive circuit applying a given selection pulse to the scanning line while the erasing pulse is applied to the specific signal line.

### BACKGROUND OF THE INVENTION

1. Field of the Invention

The present invention relates to a display unit that displays an image with the use of a light emitting device arranged for every pixel and a method of driving the same. The present invention further relates to an electronics device including the foregoing display unit.

2. Description of the Related Art

In recent years, in the field of display units for displaying images, display units including a current drive type optical device with the light emitting luminance changeable according to the flowing current value such as an organic EL (electro luminescence) device as a light emitting device of a pixel have been developed, and such display units are facilitated to be commercialized.

The organic EL device is a self-light emitting device differently from a liquid crystal device or the like. Thus, a display unit (organic EL display unit) including the organic EL device does not need a light source (backlight). Accordingly, in the organic EL display unit, compared to a liquid crystal display unit necessary for a light source, the image visibility is high, the electric power consumption is low, and the device response rate is high.

Drive systems in the organic EL display unit include simple (passive) matrix system and active matrix system as the drive system thereof as in the liquid crystal display unit. The former system has a disadvantage that it is difficult to realize a large and high definition display unit, though its structure is simple. Thus, currently, the active matrix system has been actively developed. In such a system, a current flowing through a light emitting device arranged for every pixel is controlled by an active deice provided in a drive circuit provided for every light emitting device (in general, TFT (Thin Film Transistor)).

### SUMMARY OF THE INVENTION

In general, in the organic EL display unit, in executing light emission and light extinction of the organic EL device during one frame period, a duty ratio as a ratio of light emitting period during one field period (light emitting period/1 field period*100) is constant for all pixels. Thus, in the case where the number of gradations is increased, the voltage value capable of being applied to a signal line is increased. However, in this case, the voltage value difference between each gradation becomes small, and gradation control becomes difficult.

In view of the foregoing disadvantage, in the invention, it is desirable to provide a display unit with which gradation control is facilitated, a method of driving the same, and an electronics device.

According to an embodiment of the invention, there is provided a display unit including a pixel circuit array section that includes a plurality of scanning lines arranged in rows, a plurality of signal lines arranged in columns, and a plurality of light emitting devices and a plurality of pixel circuits arranged in a matrix state correspondingly to an intersection of each scanning line and each signal line. The display unit further includes a signal line drive circuit and a scanning line drive circuit. The signal line drive circuit sequentially applies a signal voltage corresponding to a video signal to each signal line, and applies an erasing pulse to a specific signal line at given timing so that a duty ratio determined based on the video signal is obtained. The scanning line drive circuit applies a given selection pulse to the scanning line while the erasing pulse is applied to the specific signal line.

According to an embodiment of the invention, there is provided an electronics device including the foregoing display unit.

According to an embodiment of the invention, there is provided a method of driving a display unit including the following three steps:
A. a step of preparing a display unit including the following structure,
B. a step of sequentially applying a signal voltage corresponding to a video signal to each signal line, and applying an erasing pulse to a specific signal line at given timing so that a duty ratio determined based on the video signal is obtained; and
C. a step of applying a given selection pulse to a scanning line while the erasing pulse is applied to the specific signal line.

The display unit for which the foregoing method of driving the same is used includes a pixel circuit array section and a drive circuit that drives the pixel circuit array section. The pixel circuit array section includes a plurality of scanning lines arranged in rows, a plurality of signal lines arranged in columns, and a plurality of light emitting devices and a plurality of pixel circuits arranged in a matrix state correspondingly to an intersection of each scanning line and each signal line.

In the display unit, the method of driving the same, and the electronics device of the embodiments of the invention, the signal voltage corresponding to the video signal is sequentially applied to each signal line, and the erasing pulse is applied to the specific signal line at given timing so that the duty ratio determined based on the video signal is obtained. Further, the given selection pulse is applied to the scanning line while the erasing pulse is applied to the specific signal line. Thereby, not only that a height value of the signal voltage is able to be set for every pixel, but also the duty ratio is able to be set for every pixel.

According to the display unit, the method of driving the same, and the electronics device of the embodiments of the invention, not only that the height value of the signal voltage is able to be set for every pixel, but also the duty ratio is able to be set for every pixel. Thereby, gradation control is able to be facilitated.

Other and further objects, features and advantages of the invention will appear more fully from the following description.

### BRIEF DESCRIPTION OF THE DRAWINGS

FIG. 1 is a structural view illustrating an example of a display unit according to an embodiment of the invention.

FIG. 2 is a structural view illustrating an example of an internal structure of the pixel circuit array section of FIG. 1.

FIG. 3 is a diagram conceptually illustrating a state that one field is divided into five periods.

FIG. 4 is a relation diagram between duty ratios and modes.

FIG. 5 is a waveform chart for explaining an example of operation in mode 3 of the display unit of FIG. 1.

FIG. 6 is a waveform chart for explaining an example of operation in mode 4 of the display unit of FIG. 1.

FIG. 7 is a plan view illustrating a schematic structure of a module including the display unit of the foregoing embodiment.

FIG. 8 is a perspective view illustrating an appearance of a first application example of the display unit of the foregoing embodiment.

FIG. 9A is a perspective view illustrating an appearance viewed from the front side of a second application example, and FIG. 9B is a perspective view illustrating an appearance viewed from the rear side of the second application example.

FIG. 10 is a perspective view illustrating an appearance of a third application example.

FIG. 11 is a perspective view illustrating an appearance of a fourth application example.

FIG. 12A is an elevation view of a fifth application example unclosed, FIG. 12B is a side view thereof, FIG. 12C is an elevation view of the fifth application example closed, FIG. 12D is a left side view thereof, FIG. 12E is a right side view thereof, FIG. 12F is a top view thereof, and FIG. 12G is a bottom view thereof.

### DETAILED DESCRIPTION OF THE PREFERRED EMBODIMENT

An embodiment of the invention will be hereinafter described in detail with reference to the drawings. The description will be given in the following order:
1. Embodiment
1.1 Schematic structure of display unit
1.2 Operation of video signal processing circuit
1.3. Operation of display unit
1.4. Action and effect
2. Module and application examples

### 1. Embodiment

1.1 Schematic Structure of Display Unit

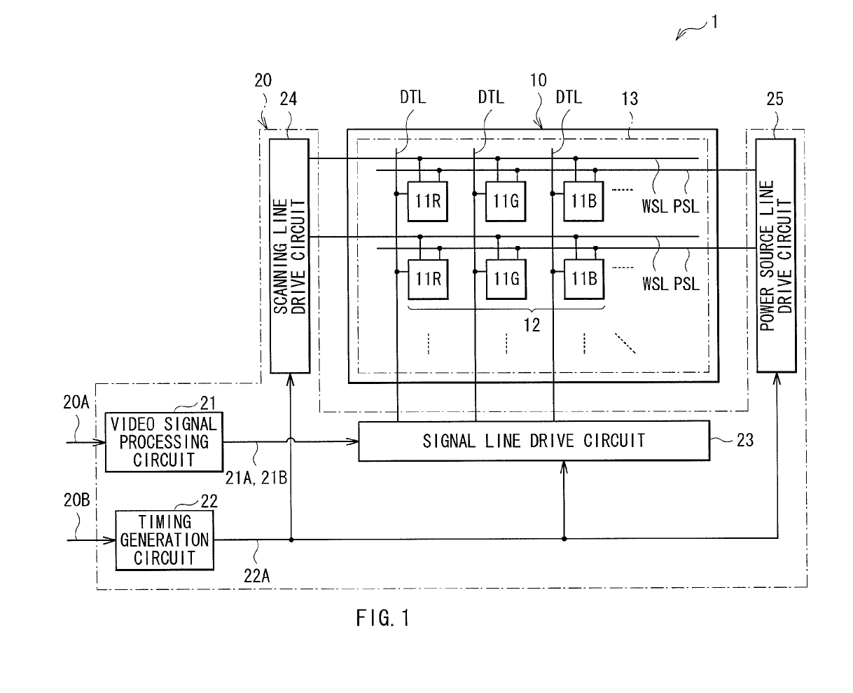

FIG. 1 illustrates a schematic structure of a display unit 1 according to an embodiment of the invention. The display unit 1 includes a display panel 10 and a drive circuit 20. The display panel 10 has a pixel circuit array section 13 in which, for example, a plurality of organic EL devices 11R, 11G, and 11B (light emitting device) are arranged in a matrix state. In this embodiment, for example, a combination of three organic EL devices 11R, 11G, and 11B adjacent to each other composes one pixel 12. In the following description, as a generic term of the organic EL devices 11R, 11G, and 11B, an organic EL device 11 is used as appropriate. The drive circuit 20 drives the pixel circuit array section 13, and, for example, has a video signal processing circuit 21, a timing generation circuit 22, a signal line drive circuit 23, a scanning line drive circuit 24, and a power source line drive circuit 25.

Pixel Circuit Array Section

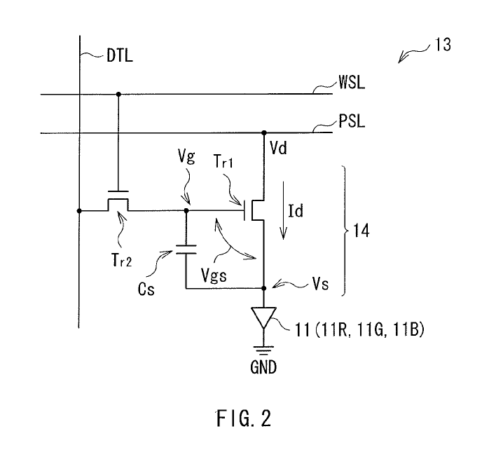

FIG. 2 illustrates an example of a circuit structure of the pixel circuit array section 13. The pixel circuit array section 13 is formed in a display region of the display panel 10. For example, as illustrated in FIG. 1 and FIG. 2, the pixel circuit array section 13 has a plurality of scanning lines WSL arranged in rows, a plurality of signal lines DTL arranged in columns, and a plurality of power source lines PSL arranged in rows along the scanning lines WSL. The plurality of organic EL devices 11 and pixel circuits 14 are arranged in a matrix state (two dimensional arrangement) correspondingly to an intersection of each scanning line WSL and each signal line DTL. The pixel circuit 14 is composed of, for example, a drive transistor Tᵣ₁, a writing transistor Tᵣ₂, and a retentive capacity Cₛ, and has a circuit structure of 2Tr1C. The drive transistor Tᵣ₁ and the writing transistor Tᵣ₂ are formed from, for example, an n channel MOS type thin film transistor (TFT (Thin Film Transistor)). The TFT type is not particularly limited, and may be, for example, inversely staggered structure (so-called bottom gate type) or staggered structure (top gate type). Further, the drive transistor Tᵣ₁ or the writing transistor Tᵣ₂ may be a p channel MOS type TFT.

In the pixel circuit array section 13, each signal line DTL is connected to an output terminal (not illustrated) of the signal line drive circuit 23 and a drain electrode (not illustrated) of the writing transistor Tᵣ₂. Each scanning line WSL is connected to an output terminal (not illustrated) of the scanning line drive circuit 24 and a gate electrode (not illustrated) of the writing transistor Tᵣ₂. Each power source line PSL is connected to an output terminal (not illustrated) of the power source line drive circuit 25 and a drain electrode (not illustrated) of the drive transistor Tᵣ₁. A source electrode (not illustrated) of the writing transistor Tᵣ₂ is connected to a gate electrode (not illustrated) of the drive transistor Tᵣ₁ and one end of the retentive capacity Cₛ. A source electrode (not illustrated) of the drive transistor Tᵣ₁ and the other end of the retentive capacity Cₛ are connected to an anode electrode (not illustrated) of the organic EL device 11. A cathode electrode (not illustrated) of the organic EL device 11 is connected to, for example, a ground line GND. The cathode electrode is used as a common electrode of each organic EL device 11, for example, is formed continuously over the entire display region of the display panel 10, and is in a state of a flat plate.

Drive Circuit

Next, a description will be given of each circuit in the drive circuit 20 provided around the pixel circuit array section 13 with reference to FIG. 1.

The video signal processing circuit 21 is intended to perform a specified correction of a digital video signal 20A inputted from outside, and output a corrected video signal 21A to the signal line drive circuit 23. Examples of the specified correction include gamma correction and overdrive correction. Further the video signal processing circuit 21 is intended to determine a duty ratio between light emitting period and light extinction period as a ratio of light emitting period during one field period (light emitting period/1 field period*100). Specifically, the video signal processing circuit 21 is intended to determine timing of outputting an erasing pulse (described later) determining the duty ratio and the signal line DTL to which the erasing pulse is outputted, for example, based on the video signal 20A or the video signal 21A. The video signal processing circuit 21 is, for example, intended to output an erasing control signal 21B indicating the determined timing and the determined signal line DTL to which the erasing pulse is outputted to the signal line drive circuit 23.

The timing generation circuit 22 is intended to execute control so that the signal line drive circuit 23, the scanning line drive circuit 24, and the power source line drive circuit 25 are operated in conjunction with each other. The timing generation circuit 22 is intended to output a control signal 22A to the foregoing respective circuits according to (in sync with), for example, a synchronization signal 20B inputted from outside.

The signal line drive circuit 23 is intended to apply an analog video signal corresponding to the video signal 21A to each signal line DTL according to (in sync with) input of the control signal 22A, and to write the analog video signal or a signal corresponding thereto into the pixel circuit 14 as a selection target. Specifically, the signal line drive circuit 23 is intended to apply a signal voltage V_{sig} corresponding to the video signal 21A to each signal line DTL, and perform writing into the pixel circuit 14 as a selection target. Writing means applying a given voltage to the gate of the drive transistor Tr₁.

Further, the signal line drive circuit 23 is intended to sequentially apply a selection voltage according to the duty ratio size set by the video signal processing circuit 21 to each signal line according to (in sync with) input of the control signal 22A, and perform writing into the pixel circuit as a selection target. Specifically, the signal line drive circuit 23 is intended to apply a voltage Vₑᵣₛ as a selection voltage to a specific signal line DTL according to input of the erasing control signal 21B outputted from the video signal processing circuit 21, and perform writing into the pixel circuit 14 as a selection target. In other words, the signal line drive circuit 23 is intended to apply the erasing pulse to decreasing the voltage from V_{sig} to Vₑᵣₛ to the specific signal line DTL according to input of the erasing control signal 21B outputted from the video signal processing circuit 21, and perform writing into the pixel circuit 14 as a selection target. Further, it is possible that the signal line drive circuit 23 applies a voltage V_{ofs} as a selection voltage to the specific signal line DTL according to input of the erasing control signal 21B outputted from the video signal processing circuit 21, and does not perform writing into the pixel circuit 14 as a selection target.

The signal line drive circuit 23 is able to output, for example, the signal voltage V_{sig} and the voltages V_{ofs1} and Vₑᵣₛ applied to the gate of the drive transistor Tr₁ at the time of light extinction of the organic EL device 11. The value of the voltage V_{ofs} is lower than that of a threshold voltage Vₑ₁ of the organic EL device 11 (constant value), and is higher than that of V_{M}−V_{th-ws}. The voltage V_{ofs} is applied to the signal line DTL during the after-mentioned erasing selection period in the case where non-erasing is selected by the erasing control signal 21B.

The voltage V_{M} is a voltage (constant value) applied to the scanning line WSL during the after-mentioned erasing selection period Tₑᵣₛ in the case where erasing is selected by the video signal processing circuit 21. The value of the voltage V_{M} is higher than that of a voltage V_{L} and lower than that of a voltage V_{H} (constant value). The value of the voltage V_{L} is lower than that of an ON voltage of the writing transistor Tr₂ (constant value). The value of the voltage V_{H} is equal to or higher than that of the ON voltage of the writing transistor Tr₂ (constant value). The voltage V_{th-ws} is a threshold voltage of the writing transistor Tr₂. The voltage Vₑᵣₛ is applied to the signal line DTL during the after-mentioned erasing selection period Tₑᵣₛ in the case where erasing is selected by the video signal processing circuit 21. The value of the voltage Vₑᵣₛ is higher than V_{L}−V_{th-ws} and lower than V_{M}−V_{th-ws} (constant value).

The scanning line drive circuit 24 sequentially applies a selection pulse to the plurality of scanning lines WSL according to (in sync with) input of the control signal 22A, and sequentially selects the plurality of organic EL devices 11 and the plurality of pixel circuits 14. Further, according to (in sync with) input of the control signal 22A, during the time period when the foregoing selection voltage (voltage Vₑᵣₛ) is applied to the signal line DTL, the scanning line drive circuit 24 applies a selection pulse having a height value (voltage V_{M}) smaller than a height value (voltage V_{H}) of a selection pulse applied during the time period other than the time period when the foregoing selection voltage (voltage Vₑᵣₛ) is applied to the signal line DTL to the scanning lien WSL. For example, the scanning line drive circuit 24 is able to output the voltage V_{H} applied in the case where the writing transistor Tr₂ is turned on, the voltage V_{M} applied in the case where whether the writing transistor Tr₂ is turned on or off is selected, and the voltage V_{L} applied in the case where the writing transistor Tr₂ is turned off.

The power source line drive circuit 25 is intended to sequentially apply a control pulse to the plurality of power source lines PSL according to (in sync with) input of the control signal 22A, and control light emission and light extinction of the organic EL device 11. For example, the power source line drive circuit 25 is able to output a voltage V_{ccH} applied in the case where a current is flown to the drive transistor Tr₁ and a voltage V_{ccL} applied in the case where a current is not flown to the drive transistor Tr₁. The value of the voltage V_{ccL} is lower than that of a voltage obtained by adding a threshold voltage Vₑ₁ of the organic EL device 11 to a voltage V_{ca} of the cathode of the organic EL device 11 (Vₑ₁+V_{ca}) (constant value). The value of V_{ccH} is equal to or higher than that of the voltage (Vₑ₁+V_{ca}) (constant value).

1.2 Operation of Video Signal Processing Circuit 21

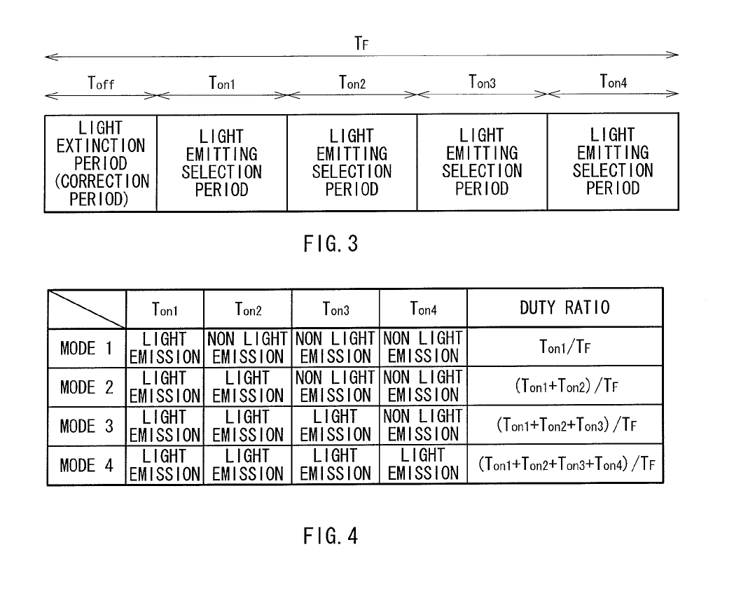

FIG. 3 illustrates an example of processing flow in the video signal processing circuit 21. The video signal processing circuit 21 sets the duty ratio as follows. For example, as illustrated in FIG. 3, the video signal processing circuit 21 separates one frame period T_{F} into light extinction period T_{off}, light emitting selection period Tₒₙ₁, light emitting selection period Tₒₙ₂, light emitting selection period Tₒₙ₃, and light emitting selection period Tₒₙ₄. The light extinction period T_{off} is also period when Vₜₕ correction, μ correction and the like are performed as described later. Next, for example, as illustrated in FIG. 4, the video signal processing circuit 21 selects the duty ratio corresponding to the size of the video signal 20A or the video signal 21A from the group consisting of duty ratios of mode 1 to mode 4.

Mode 1 is a mode for selecting “light emission” during the light emitting selection period Tₒₙ₁, and selecting “non light emission” during the light emitting selection periods Tₒₙ₂, Tₒₙ₃, and Tₒₙ₄. Mode 2 is a mode for selecting “light emission” during the light emitting selection periods Lₒₙ₁ and Tₒₙ₂, and selecting “non light emission” during the light emitting selection periods Tₒₙ₃ and Tₒₙ₄. Mode 3 is a mode for selecting “light emission” during the light emitting selection periods Tₒₙ₁, Tₒₙ₂, Tₒₙ₃, and selecting “non light emission” during the light emitting selection period Tₒₙ₄. Mode 4 is a mode for selecting “light emission” during the light emitting selection periods Lₒₙ₁, Tₒₙ₂, Tₒₙ₃, and Tₒₙ₄.

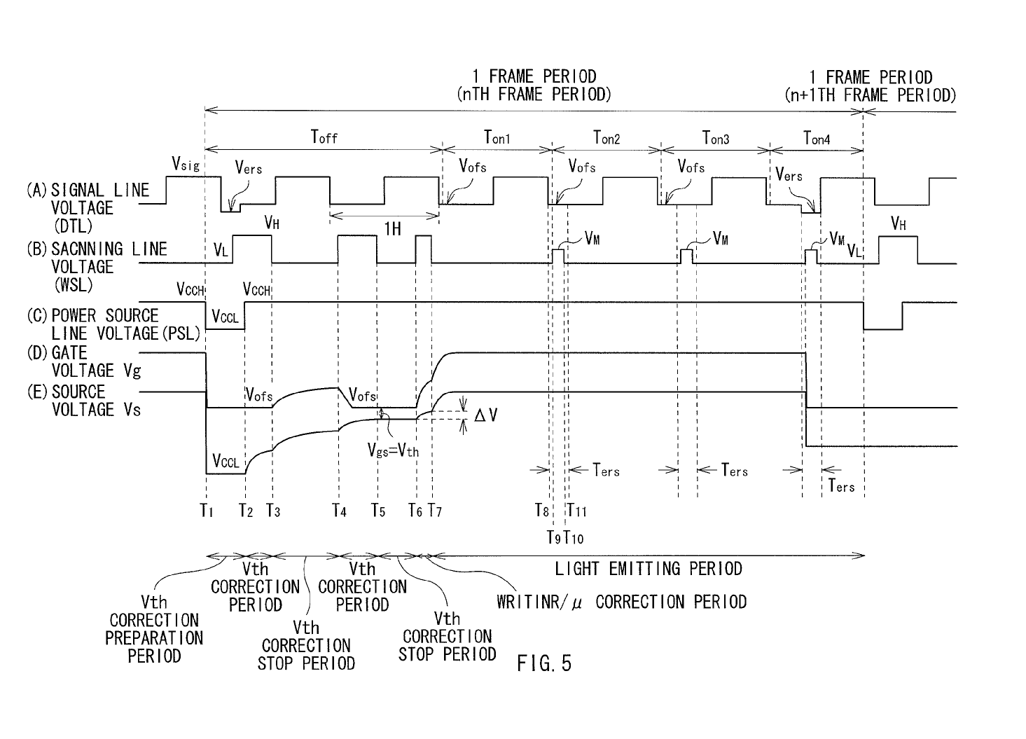

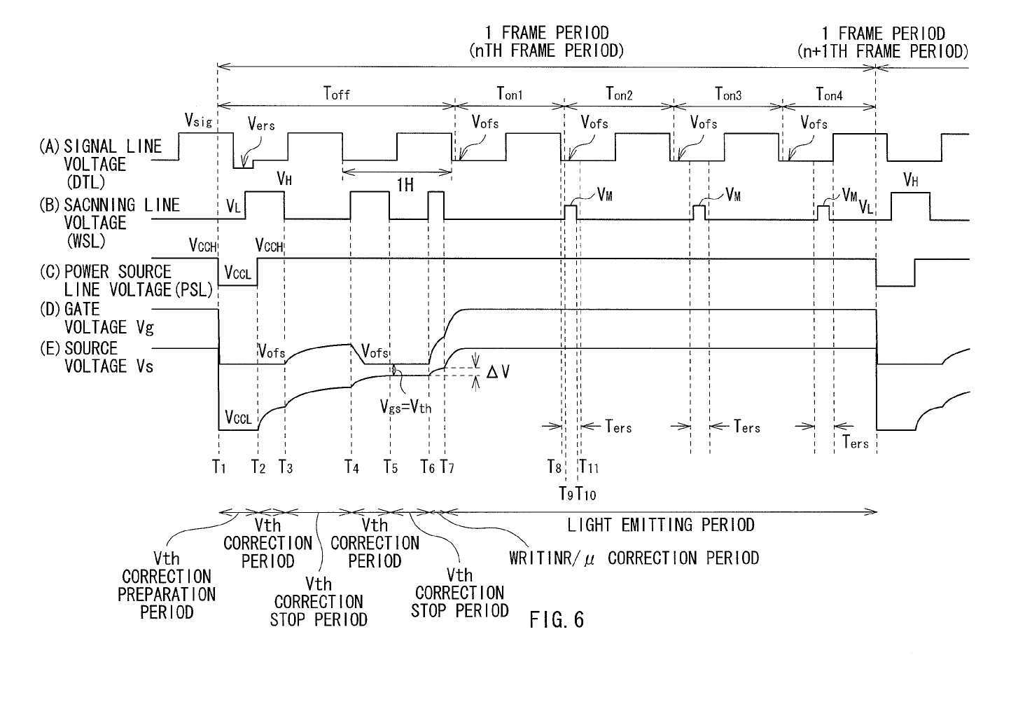

Next, the video signal processing circuit 21 outputs the video signal 21A to the signal line drive circuit 23 at given timing, and outputs the erasing control signal 21B corresponding to the mode to the signal line drive circuit 23 at given timing. For example, in the case where the erasing control signal 21B is applied to the signal line drive circuit 23 in the case of mode 3, the signal line drive circuit 23 applies the voltage V_{ofs} to the signal line DTL during the first to the third erasing selection periods Tₑᵣₛ in FIG. 5, and applies the voltage Vₑᵣₛ to the signal line DTL during the fourth erasing selection period Tₑᵣₛ in FIG. 5. Further, for example, in the case where the erasing control signal 21B is applied to the signal line drive circuit 23 in the case of mode 4, the signal line drive circuit 23 applies the voltage V_{ofs} to the signal line DTL during the all erasing selection periods Tₑᵣₛ in FIG. 6.

1.3. Operation of Display Unit

FIG. 5 illustrates an example of various waveforms in the case where the display unit 1 is driven in mode 3. FIG. 6 illustrates an example of various waveforms in the case where the display unit 1 is driven in mode 4. Part A to part C in FIG. 5 and part A to part C in FIG. 6 illustrate a state in which V_{ofs1}, V_{ofs2}, and Vₑᵣₛ are cyclically applied to the signal line DTL, V_{H}, V_{L}, and V_{M} are applied to the scanning line WSL at given timing, and V_{ccL} and V_{ccH} are applied to the power source line PSL at given timing. Part D and part E in FIG. 5 and part D and part E in FIG. 6 illustrate a state in which a gate voltage V_{g} and a source voltage Vₛ of the drive transistor Tr₁ are ever-changed according to applying a voltage to the signal line DTL, the scanning line WSL, and the power source line PSL. A description will be firstly given of operation common to all modes, and subsequently of respective operations of the respective modes.

Vₜₕ Correction Preparation Period

First, Vₜₕ correction preparation is performed. Specifically, the power source line drive circuit 25 decreases the voltage of the power source line PSL from V_{ccH} to V_{ccL} (T₁). Accordingly, the source voltage Vₛ becomes V_{ccL}, the organic EL device 11 is extinct, and the gate voltage V_{g} is decreased down to V_{ofs}. Next, while the voltage of the signal line DTL is V_{ofs} and the voltage of the power source line PSL is V_{ccL}, the scanning line drive circuit 24 increases the voltage of the scanning line WSL from V_{L} to V_{H}.

First Vₜₕ Correction Period

Next, Vₜₕ correction is performed. Specifically, while the voltage of the signal line DTL is V_{ofs}, the power source line drive circuit 25 increases the voltage of the power source line PSL from V_{ccL} to V_{ccH} (T₂). Accordingly, a current I_{d} is flown between the drain and the source of the drive transistor Tr₁, and the source voltage Vₛ is increased. After that, before the signal line drive circuit 23 changes the voltage of the signal line DTL from V_{ofs} to V_{sig}, the scanning line drive circuit 24 decreases the voltage of the scanning line WSL from V_{H} to V_{L} (T₃). Accordingly, the gate of the drive transistor Tr₁ becomes floating, and Vₜₕ correction is stopped at once.

First Vₜₕ Correction Stop Period

While Vₜₕ correction is stopped, in a row (pixel) different from the row (pixel) provided with the precedent Vₜₕ correction, sampling of the voltage of the signal line DTL is performed. In the case where Vₜₕ correction is not sufficient, that is, in the case where an electric potential difference V_{gs} between the gate and the source of the drive transistor Tr₁ is larger than the threshold voltage Vₜₕ of the drive transistor Tr₁, it results in as follows. That is, even in the Vₜₕ correction stop period, in the row (pixel) provided with the precedent Vₜₕ correction, a current I_{ds} is flown between the drain and the source of the drive transistor Tr₁, the source voltage Vₛ is increased, and the gate voltage V_{g} is also increased due to coupling through the retentive capacity Cₛ.

Second Vₜₕ Correction Period

After the Vₜₕ correction stop period is finished, Vₜₕ correction is performed again. Specifically, while the voltage of the signal line DTL is V_{ofs} and Vₜₕ correction is available, the scanning line drive circuit 24 increases the voltage of the scanning line WSL from V_{L} to V_{H} (T₄), and connects the gate of the drive transistor Tr₁ to the signal line DTL. At this time, in the case where the source voltage Vₛ is lower than (V_{ofs}−Vₜₕ) (in the case where Vₜₕ correction is not completed yet), the current I_{d} is flown between the drain and the source of the drive transistor Tr₁ until the drive transistor Tr₁ is cut off (until the electric potential difference V_{gs} becomes Vₜₕ). In the result, the retentive capacity Cₛ is charged with Vₜₕ, and the electric potential difference V_{gs} becomes Vₜₕ. After that, before the signal line drive circuit 23 changes the voltage of the signal line DTL from V_{ofs} to V_{sig}, the scanning line drive circuit 24 decreases the voltage of the scanning line WSL from V_{H} to V_{L} (T₅). Accordingly, the gate of the drive transistor Tr₁ becomes floating, and thus the electric potential difference V_{gs} is kept at Vₜₕ without relation to the voltage size of the signal line DTL. As described above, by setting the electric potential difference V_{gs} to Vₜₕ, even if the threshold voltage Vₜₕ of the drive transistor Tr₁ varies according to each pixel circuit 14, variation of the light emitting luminance of the organic EL device 11 is able to be prevented.

Second Vₜₕ Correction Stop Period

After that, while Vₜₕ correction is stopped, the signal line drive circuit 23 changes the voltage of the signal line DTL from V_{ofs} to V_{sig}.

Writing and μ Correction Period

After the Vₜₕ correction stop period is finished, writing and μ correction are performed. Specifically, while the voltage of the signal line DTL is V_{sig}, the scanning line drive circuit 24 increases the voltage of the scanning line WSL from V_{L} to V_{H} (T₆), and connects the gate of the drive transistor Tr₁ to the signal line DTL. Accordingly, the gate voltage of the drive transistor Tr₁ becomes V_{sig}. At this time, an anode voltage of the organic EL device 11 is smaller than the threshold voltage Vₑ₁ of the organic EL device 11 yet in this stage, and the organic EL device 11 is cut off Thus, the current I_{ds} is flown to a device capacity (not illustrated) of the organic EL device 11, and the device capacity is charged. Thus, the source voltage Vₛ is increased by ΔV, and the electric potential difference V_{gs} becomes V_{sig}+Vₜₕ−ΔV. As described above, μ correction is performed concurrently with writing. As mobility μ of the drive transistor Tr₁ is larger, ΔV becomes larger. Thus, by decreasing the electric potential difference V_{gs} by ΔV before light emission, variation of the mobility μ for every pixel circuit 14 is able to be removed.

Light Emission Selection Period (Tₒₙ₁)

Next, the scanning line drive circuit 24 decreases the voltage of the scanning line WSL from V_{H} to V_{L} (T₇). Accordingly, the gate of the drive transistor Tr₁ becomes floating, the voltage V_{gs} between the gate and the source of the drive transistor Tr₁ is maintained constantly, while the current I_{d} is flown between the drain and the source of the drive transistor Tr₁. In the result, the source voltage Vₛ is increased, the gate of the drive transistor Tr₁ is increased in conjunction therewith, and the organic EL device 11 emits light at desired luminance (T₈).

Next, a description will be given of operation in the case where mode 3 is selected with reference to FIG. 5.

Light Emitting Selection Period (Tₒₙ₁)

When a given period lapses after the organic EL device 11 starts to emit light, the signal line drive circuit 23 decreases the voltage of the signal line DTL from V_{sig} to V_{ofs} correspondingly to application of the erasing control signal 21B, and it gets to the first erasing selection period Tₑᵣₛ (T₈). Subsequently, the scanning line drive circuit 24 increases the voltage of the scanning line WSL from V_{L} to V_{M} (T₉). At this time, the voltage V_{gs} between the gate and the source of the writing transistor Tr₂ is V_{M}−V_{ofs}, and is smaller than the threshold voltage V_{th ws} of the writing transistor Tr₂. Thus, the writing transistor Tr₂ is kept off, and the gate of the drive transistor Tr₁ is kept in the floating state. Thus, the organic EL device 11 continuously emits light. After that, while the voltage of the signal line DTL is V_{ofs}, the scanning line drive circuit 24 decreases the voltage of the scanning line WSL from V_{M} to V_{L}. At this time, again, the writing transistor Tr₂ is kept off, and the gate of the drive transistor Tr₁ is kept in the floating state. Thus, the organic EL device 11 continuously emits light. After that, the signal line drive circuit 23 increases the voltage of the signal line DTL from V_{ofs} to V_{sig}.

Light Emitting Selection Period (Tₒₙ₂ and Tₒₙ₃)

On and after that, during the light emitting selection period (Tₒₙ₂ and Tₒₙ₃), the foregoing step is repeated. In the state that the organic EL device 11 continuously emits light, the second and the third erasing selection periods Tₑᵣₛ elapse.

Light Emitting Selection Period (Tₒₙ₄)

Next, the signal line drive circuit 23 decreases the voltage of the signal line DTL from V_{sig} to Vₑᵣₛ correspondingly to application of the erasing control signal 21B, and it gets to the fourth erasing selection period Tₑᵣₛ (T₈). During this erasing selection period Tₑᵣₛ, the voltage of the signal line DTL is Vₑᵣₛ, and non light emission of the organic EL device 11 is selected. That is, the erasing pulse (falling signal from the voltage V_{sig} to the voltage Vₑᵣₛ) is applied to the specific signal line DTL at timing of start of the light emitting selection period (Tₒₙ₄) so that the duty ratio determined based on the video signal 20A or the video signal 21A is obtained (T₉). Accordingly, the gate of the drive transistor Tr₁ is connected to the signal line DTL, the gate voltage of the drive transistor Tr₁ becomes Vₑᵣₛ, and the voltage V_{gs} between the gate and the source of the drive transistor Tr₁ becomes Vₑᵣₛ−Vₑ₁<Vₜₕ, and light emission of the organic EL device is stopped. That is, the signal line drive circuit 23 applies the voltage Vₑᵣₛ to the signal line DTL during the fourth erasing selection period Tₑᵣₛ correspondingly to application of the erasing control signal 21B, and a stationary current flown to the organic EL device as a selection target is stopped. After that, while the voltage of the signal line DTL is Vₑᵣₛ, the scanning line drive circuit 24 decreases the voltage of the scanning line WSL from V_{M} to V_{L}. Accordingly, the gate of the drive transistor Tr₁ is kept in the floating state. After that, light emission of the organic EL device 11 is continuously stopped.

In the display unit 1 of this embodiment, as described above, the pixel circuit 14 is on/off controlled in each pixel 12, and a drive current is injected into the organic EL device 11 of each pixel 12. Thereby, electron hole recombination is generated, leading to light emission. The light is multiply reflected between the anode and the cathode, is transmitted through the cathode or the like, and extracted outside. In the result, an image is displayed on the display panel 10.

1.4 Action and Effect

In the existing organic EL display unit, in general, in executing light emission and light extinction of the organic EL device during one frame period, the duty ratio between light emitting period and light extinction period as a ratio of light emitting period during one field period (light emitting period/1 field period*100) is constant for all pixels. Thus, in the case where the number of gradations is increased, the voltage value capable of being applied to a signal line is increased. However, in this case, the voltage value difference between each gradation becomes small, and gradation control becomes difficult.

Meanwhile, in this embodiment, writing into the pixel circuit 14 as a selection target is performed by applying the signal voltage V_{sig} corresponding to the video signal 21A to each signal line DTL. Further, the erasing pulse (voltage Vₑᵣₛ) is applied to the specific signal line DTL at given timing so that the duty ratio determined based on the video signal 20A or the video signal 21A is obtained. Further, the voltage of the scanning line WSL is increased from V_{L} to V_{M} so that the voltage V_{gs} between the gate and the source of the drive transistor Tr₁ in the pixel circuit 14 corresponding to the specific signal line DTL is lower than Vₜₕ while the erasing pulse (voltage Vₑᵣₛ) is applied to the specific signal line DTL. Thereby, light emission of the organic EL device 11 in the specific pixel 12 is stopped. Thereby, not only that the height value of the signal voltage V_{sig} is able to be set for every pixel 12, but also the duty ratio is able to be set for every pixel 12. Therefore, compared to the foregoing existing case, gradation control is more facilitated.

### 2. Module and Application Examples

A description will be given of application examples of the display unit described in the foregoing embodiment. The display unit of the foregoing embodiment is able to be applied to a display unit of electronics devices in any field for displaying a video signal inputted from outside or a video signal generated inside as an image or a video such as a television device, a digital camera, a notebook personal computer, a portable terminal device such as a mobile phone, and a video camera.

### Module

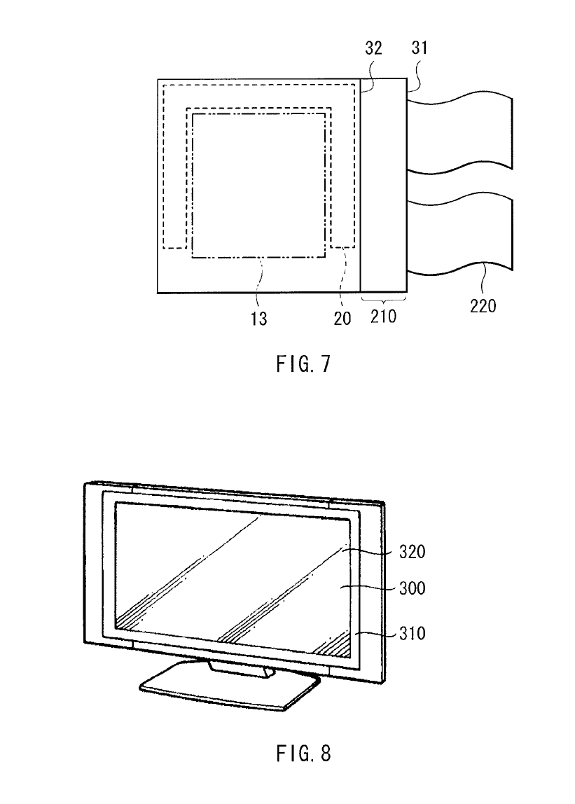

The display unit 1 of the foregoing embodiment is incorporated in various electronics devices such as after-mentioned first to fifth application examples as a module as illustrated in FIG. 7, for example. In the module, for example, a region 210 exposed from a sealing substrate 32 is provided in a side of a substrate 31, and an external connection terminal (not illustrated) is formed in the exposed region 210 by extending wirings of the drive circuit 20. The external connection terminal may be provided with a Flexible Printed Circuit (FPC) 220 for inputting and outputting a signal.

### First Application Example

FIG. 8 illustrates an appearance of a television device to which the display unit 1 of the foregoing embodiment is applied. The television device has, for example, a video display screen section 300 including a front panel 310 and a filter glass 320. The video display screen section 300 is composed of the display unit 1 according to the foregoing embodiment.

### Second Application Example

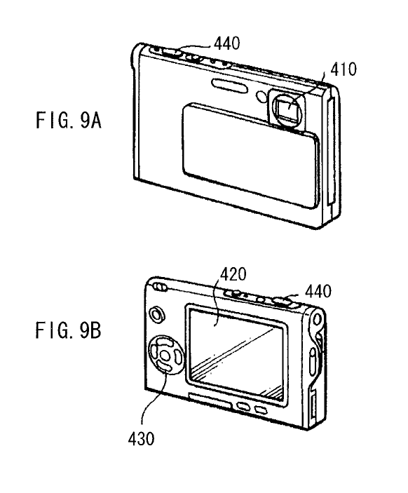

FIGS. 9A and 9B illustrate an appearance of a digital camera to which the display unit 1 of the foregoing embodiment is applied. The digital camera has, for example, a light emitting section for a flash 410, a display section 420, a menu switch 430, and a shutter button 440. The display section 420 is composed of the display unit 1 according to the foregoing embodiment.

### Third Application Example

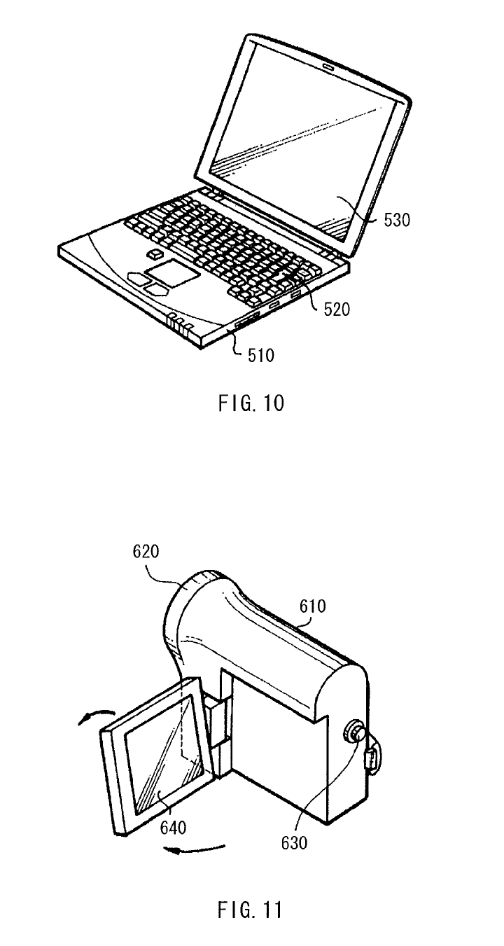

FIG. 10 illustrates an appearance of a notebook personal computer to which the display unit 1 of the foregoing embodiment is applied. The notebook personal computer has, for example, a main body 510, a keyboard 520 for operation of inputting characters and the like, and a display section 530 for displaying an image. The display section 530 is composed of the display unit 1 according to the foregoing embodiment.

### Fourth Application Example

FIG. 11 illustrates an appearance of a video camera to which the display unit 1 of the foregoing embodiment is applied. The video camera has, for example, a main body 610, a lens for capturing an object 620 provided on the front side face of the main body 610, a start/stop switch in capturing 630, and a display section 640. The display section 640 is composed of the display unit 1 according to the foregoing embodiment.

### Fifth Application Example

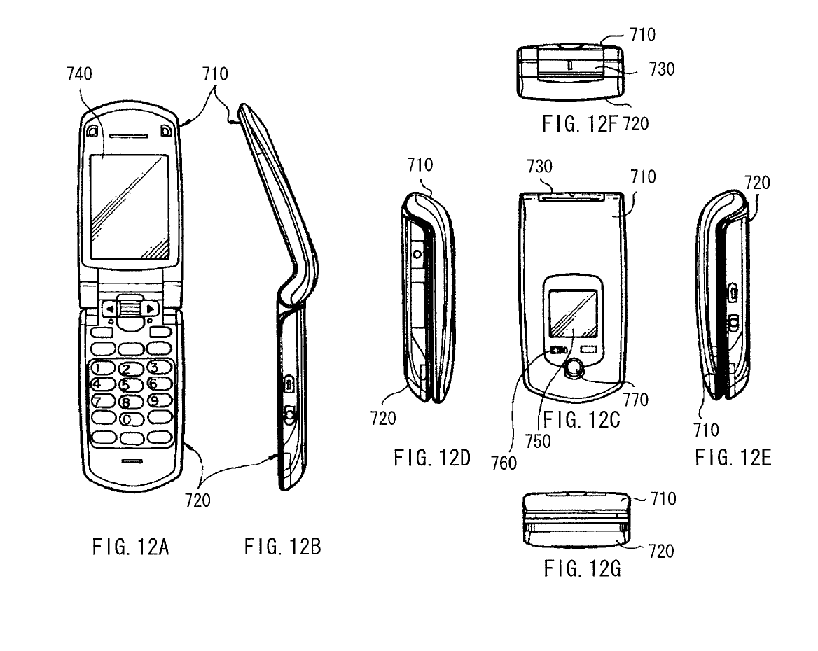

FIGS. 12A to 12G illustrate an appearance of a mobile phone to which the display unit 1 of the foregoing embodiment is applied. In the mobile phone, for example, an upper package 710 and a lower package 720 are jointed by a joint section (hinge section) 730. The mobile phone has a display 740, a sub-display 750, a picture light 760, and a camera 770. The display 740 or the sub-display 750 is composed of the display unit 1 according to the foregoing embodiment.

While the invention has been described with reference to the embodiment and the application examples, the invention is not limited to the foregoing embodiment and the like, and various modifications may be made.

For example, in the foregoing embodiment and the like, the description has been given of the case that the display unit 1 is an active matrix type. However, the structure of the pixel circuit 14 for driving the active matrix is not limited to the case described in the foregoing embodiment and the like, and a capacity device or a transistor may be added to the pixel circuit 14 according to needs. In this case, according to the change of the pixel circuit 14, a necessary drive circuit may be added in addition to the signal line drive circuit 23, the scanning line drive circuit 24, and the power source line drive circuit 25 described above.

Further, in the foregoing embodiment and the like, driving of the signal line drive circuit 23, the scanning line drive circuit 24, and the power source line drive circuit 25 is controlled by the timing control circuit 22. However, other circuit may control driving of the signal line drive circuit 23, the scanning line drive circuit 24, and the power source line drive circuit 25. Further, the signal line drive circuit 23, the scanning line drive circuit 24, and the power source line drive circuit 25 may be controlled by a hardware (circuit) or may be controlled by software (program).

Further, in the foregoing embodiment and the like, the description has been given of the case that the pixel circuit 14 has the 2Tr1C circuit structure. However, as long as a circuit structure in which a transistor is connected to the organic EL device 11 in series is included, a circuit structure other than the 2Tr1C circuit structure may be adopted.

Further, in the foregoing embodiment and the like, the description has been given of the case that the drive transistor Tᵣ₁ and the writing transistor Tᵣ₂ are formed from the n channel MOS type thin film transistor (TFT). However, it is possible that the drive transistor Tᵣ₁ and the writing transistor Tᵣ₂ are formed from a p channel transistor (for example, p channel MOS type TFT). However, in this case, it is preferable that one of the source and the drain of the transistor Tᵣ₂ that is not connected to the power source line PSL and the other end of the retentive capacity Cₛ are connected to the cathode of the organic EL device 11, and the anode of the organic EL device 11 is connected to the GND or the like.

The present application contains subject matter related to that disclosed in Japanese Priority Patent Application JP 2009-165378 filed in the Japanese Patent Office on Jul. 14, 2009, the entire contents of which is hereby incorporated by reference.

It should be understood by those skilled in the art that various modifications, combinations, sub-combinations and alternations may occur depending on design requirements and other factors insofar as they are within the scope of the appended claims or the equivalents thereof.

What is claimed is:

1. A display unit comprising:
a pixel circuit array section that includes a plurality of scanning lines arranged in rows, a plurality of signal lines arranged in columns, and a plurality of light emitting devices and a plurality of pixel circuits arranged in a matrix state correspondingly to an intersection of each scanning line and each signal line;
a signal line drive circuit that sequentially applies a signal voltage corresponding to a video signal to each signal line, and applies an erasing pulse to a specific signal line at given timing so that a duty ratio determined based on the video signal is obtained; and
a scanning line drive circuit that applies a given selection pulse to the scanning line while the erasing pulse is applied to the specific signal line.

2. The display unit according to claim 1, wherein the scanning line drive circuit applies a selection pulse having a height value smaller than a height value of a selection pulse applied during time period other than time period when the erasing pulse is applied to the specific signal line to the scanning line while the erasing pulse is applied to the specific signal line.

3. A method of driving a display unit comprising:
a step of preparing a display unit that includes a pixel circuit array section including a plurality of scanning lines arranged in rows, a plurality of signal lines arranged in columns, and a plurality of light emitting devices and a plurality of pixel circuits arranged in a matrix state correspondingly to an intersection of each scanning line and each signal line and a drive circuit that drives the pixel circuit array section;
a step of sequentially applying a signal voltage corresponding to a video signal to each signal line, and applying an erasing pulse to a specific signal line at given timing so that a duty ratio determined based on the video signal is obtained; and
a step of applying a given selection pulse to the scanning line while the erasing pulse is applied to the specific signal line.

4. An electronics device comprising:
a display unit, wherein the display unit has
a pixel circuit array section that includes a plurality of scanning lines arranged in rows, a plurality of signal lines arranged in columns, and a plurality of light emitting devices and a plurality of pixel circuits arranged in a matrix state correspondingly to an intersection of each scanning line and each signal line,
a signal line drive circuit that sequentially applies a signal voltage corresponding to a video signal to each signal line, and applies an erasing pulse to a specific signal line at given timing so that a duty ratio determined based on the video signal is obtained, and
a scanning line drive circuit that applies a given selection pulse to the scanning line while the erasing pulse is applied to the specific signal line.
